(19) United States
(12) Patent Application Publication
(10) Pub. No.: US 2006/0098345 A1
(43) Pub. Date: May 11, 2006

(54) Head drum assembly and a magnetic recording/reproducing apparatus having the same

(75) Inventors: Myoung-Joon Kim, Suwon-si (KR); Chung-Hum Baik, Suwon-si (KR); Seung-Woo Lee, Suwon-si (KR); Tae-Gil Kang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/235,081

(22) Filed: Sep. 27, 2005

(30) Foreign Application Priority Data
Nov. 8, 2004 (KR) 2004-90279

(51) Int. Cl. G11B 21/04

(52) U.S. Cl. 360/271.1

(57) ABSTRACT

A head drum assembly comprises a stationary drum, a rotary drum, and a self-compensating dynamic balancer. The stationary drum is fixed to a shaft, and the rotary drum is rotatably mounted to the shaft so that it faces the stationary drum. The rotary drum supports a magnetic head. The self-compensating dynamic balancer automatically compensates for any eccentricity between the rotational axis and the centroid of the rotary drum by using the centrifugal force of the rotary drum being rotated.

### CROSS-REFERENCE TO RELATED APPLICATIONS

This application claims the benefit under 35 U.S.C. § 119(a) of Korean Patent Application No. 2004-90279, filed Nov. 8, 2004, the entire contents of which are hereby incorporated by reference.

### BACKGROUND OF THE INVENTION

1. Field of the Invention

The present invention relates to a head drum assembly which records and reproduces information with a running magnetic tape, and a magnetic recording/reproducing apparatus having the same. More particularly, the present invention relates to a dynamic balancer for a head drum assembly.

2. Description of the Related Art

Generally, a magnetic recording/reproducing apparatus records information on a recording medium such as a magnetic tape and reproduces the recorded information. Video cassette tape recorders (VCRs) and camcorders are examples of magnetic recording/reproducing apparatuses.

A magnetic recording/reproducing apparatus includes a head drum assembly that is rotatably mounted to a deck to record and reproduce information with respect to a magnetic tape as the tape moves past the head drum assembly. The head drum assembly is typically slanted by a predetermined angle with respect to the deck for better recording and reproduction performance.

FIG. 1 shows an example of a head drum assembly. Referring to FIG. 1, a stationary drum 11 is fixed to a shaft 10, and a rotary drum 12 is rotatably mounted to the shaft 10. A magnetic head 13 is supported by the rotary drum 12 and scans a running magnetic tape to record and reproduce information on the tape. A drum cover 14 is fixed to the shaft 10 above the rotary drum 12. The surface of the rotary drum 12 has a rotary transfer 16 and the surface of the drum cover 14 has a stationary transfer 15. The rotary transfer 16 and stationary transfer 14 face each other and convert a magnetic signal to an electric signal and transmit the converted signal.

A motor rotor 17 is mounted on the rotary drum 12. The motor rotor 17 comprises a bracket 17a fastened to the rotary drum 12, and a magnet 17b supported by the bracket 17a. A motor stator 18 is mounted to the stationary drum 11 and faces the motor rotor 17. The motor stator 18 and the motor rotor 17 cooperate with one another to generate a driving force for rotating the rotary drum 12.

With this construction, the rotary drum 12 supporting the magnetic head 13 rotates with the motor rotor 17 at a high speed. During the rotation of the rotary drum 12, the magnetic head 13 records or reproduces information on the magnetic tape.

In the above-structured rotary drum 12, the rotational axis of the rotary drum may not correspond to the centroid of the rotary drum due to manufacturing and assembly errors. When the centroid is not aligned with the rotational axis (that is, they are eccentric with respect to each other), the rotary drum may be unstable, thereby degrading recording and reproducing performance of the rotary drum 12.

Therefore, in the conventional art, a predetermined balancing apparatus is used to measure eccentricity and an eccentric position. Once measured, a mass body 19 is attached to a suitable location that compensates for the measured eccentricity. For instance, a mass body 19 comprising a certain amount of a hard bond may be placed and hardened on the bracket 17a to compensate for eccentricity.

Compensation of the eccentricity of the rotary drum 12 using a dedicated mass body 19 requires complicated processes. In detail, the rotary drum 12 (with the mounted magnetic head 13 and motor rotor 17) is rotatably supported by a shaft, which is provided just for measurement. The rotary drum 12 is rotated, and the eccentricity and an eccentric position of the rotary drum 12 are measured. A predetermined mass body 19 is attached to a location that compensates for the eccentricity, according to the measured result. The eccentricity of the rotary drum 12 is then measured again by rotating the drum. If the measured eccentricity of the rotary drum 12 passes a predetermined reference standard, the rotary drum 12 is removed from the shaft and the next processes are performed. Thus, balancing the rotary drum 12 takes considerable time and involves complicated processes, thereby degrading productivity and increasing manufacturing costs.

Accordingly, there is a need for an improved head drum assembly that compensates for eccentricity more efficiently.

### SUMMARY OF THE INVENTION

An aspect of the present invention is to address at least the above problems and/or disadvantages. Accordingly, an aspect of the present invention is to provide a head drum assembly that is capable of automatically compensating for any eccentricity of a rotary drum without requiring a dedicated balancing process, and a magnetic recording/reproducing apparatus having the same.

In an exemplary embodiment of the present invention, a head drum assembly comprises a stationary drum, a rotary drum, and a self-compensating dynamic balancer. The stationary drum is fixed to a shaft, and the rotary drum is rotatably mounted to the same shaft. The rotary drum faces the stationary drum and supports a magnetic head. The self-compensating dynamic balancer automatically compensates for any eccentricity between the rotational axis and the centroid of the rotary drum by using the centrifugal force of the rotary drum being rotated.

In another aspect of the present invention, the self-compensating dynamic balancer comprises a recessed race groove. The race groove is annular with respect to the rotational axis of the rotary drum. A plurality of mobile members are received in the race groove and move in a direction that compensates for the eccentricity of the rotary drum when the rotary drum is rotated.

In yet another aspect of the present invention, the self-compensating dynamic balancer further comprises a cover member that covers an open top portion of the race groove to prevent the mobile members from escaping from the race groove.

In one more aspect of the present invention, the cover member is connected by press fit with an inner circumferential wall of the race groove.

In a further aspect of the present invention, the inner circumferential wall of the race groove has a supporting projection for restricting the connection height of the cover member.

In another aspect of the present invention, the mobile members comprise balls.

In yet one more aspect of the present invention, the outer circumferential wall of the race groove has a plurality of receiving recesses in which the balls are received when the rotary drum is rotated.

In a further aspect of the present invention, the receiving recesses are disposed at constant intervals along the outer circumferential wall of the race groove.

In yet another aspect of the present invention, the receiving recesses are semicircular indentations formed in the outer circumferential wall of the race groove

In one more aspect of the present invention, the race groove is formed on an upper surface of the rotary drum to face the magnetic head.

In another exemplary embodiment of the present invention, a magnetic recording/reproducing apparatus comprises a deck and a head drum assembly mounted to the deck. The head drum assembly comprises a stationary drum, a rotary drum, and a self-compensating dynamic balancer. The stationary drum is fixed to a shaft, and the rotary drum is rotatably mounted to the same shaft. The rotary drum faces the stationary drum and supports a magnetic head. The self-compensating dynamic balancer automatically compensates for any eccentricity between the rotational axis and the centroid of the rotary drum by using the centrifugal force of the rotary drum being rotated.

### BRIEF DESCRIPTION OF THE DRAWING FIGURES

The above and other objects, features, and advantages of certain embodiments of the present invention will be more apparent from the following description taken in conjunction with the accompanying drawings, in which:

FIG. 1 is a schematic sectional view of a conventional head drum assembly;

FIG. 2 is a sectional view of a magnetic recording/reproducing apparatus according to an embodiment of the present invention;

FIG. 3 is a plan view of the rotary drum of FIG. 2; and

FIG. 4 is a partial, sectional view of certain elements of FIG. 2.

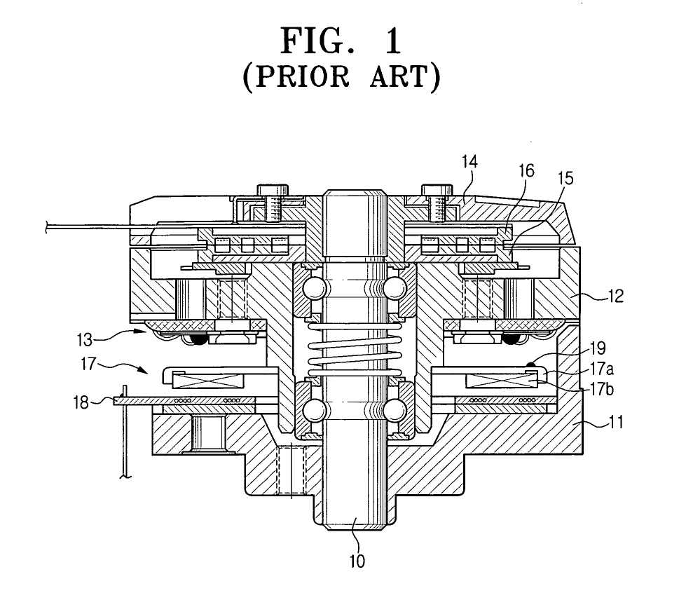

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

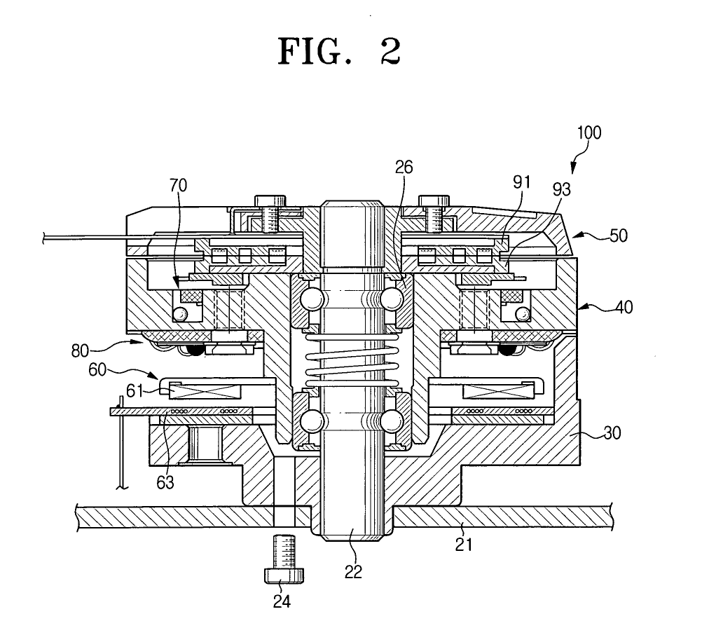

Referring to FIG. 2, a magnetic recording/reproducing apparatus according to an embodiment of the present invention comprises a deck 21 and a head drum assembly 100 mounted to the deck 21. The deck 21 is mounted within a main body of the magnetic recording/reproducing apparatus, such as a camcorder, for recording and reproducing information on a magnetic tape. The deck 21 includes a driving device for transporting the magnetic tape and a guiding device for guiding the magnetic tape. A mechanism using such a deck 21 is generally known by those in the art, and, therefore, a detailed description is omitted for conciseness.

The head drum assembly 100 comprises a stationary drum 30 fixed to a shaft 22, a rotary drum 40 rotatably mounted on the shaft 22 above the stationary drum 30, a drum cover 50 mounted above the rotary drum 40, a drum motor 60 for rotating the rotary drum 40, and a self-compensating dynamic balancer 70.

The stationary drum 30 fits around the shaft 22 and is fastened to the deck 21 by a screw 24.

The rotary drum 40 fits around the shaft 22 to face the stationary drum 30. A bearing 26 is interposed between the rotary drum 40 and the shaft 22.

A magnetic head 80 is supported by the rotary drum 40 and scans a magnetic tape running past the magnetic head 80 to record information on the magnetic tape or reproduce recorded information from the magnetic tape. The magnetic head 80 is preferably disposed under the rotary drum 40.

The drum cover 50 is disposed above the rotary drum 50 and fits around the shaft 22. The rotary drum 50 has a rotary transfer 91, and the drum cover 40 has a stationary transfer 93. The rotary transfer 91 and stationary transfer 93 cooperate to transmit the information read from the magnetic head 80.

The drum motor 60 comprises a rotor 61 mounted to the rotary drum 40, and a stator 63 mounted to the stationary drum 30.

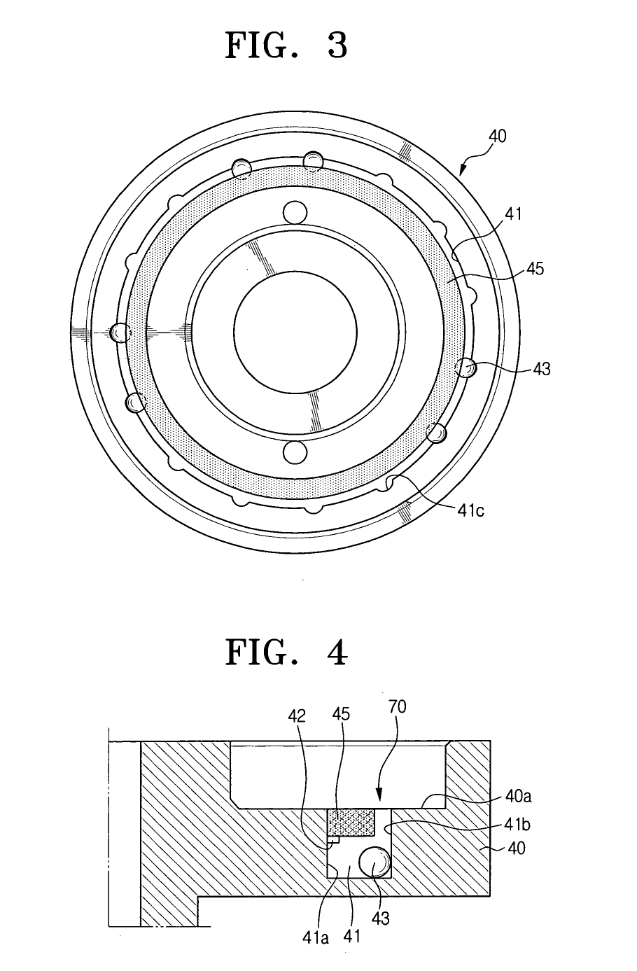

The self-compensating dynamic balancer 70, as shown in FIGS. 3 and 4, comprises a race groove 41 located in the rotary drum 40, at least one mobile member 43 received in the race groove 41, and a cover member 45.

The race groove 41 is annular, and is formed around the rotational axis of the rotary drum 40. More preferably, the race groove 41 is formed on an upper surface 40a of the rotary drum 40, and has a predetermined depth.

In the illustrated exemplary embodiment, a plurality of mobile members 43 are received in the race groove 41 and are movable. The mobile members 43 may be metal balls. When the rotary drum 40 rotates, the mobile members 43 move in a direction that is symmetrical with the eccentric point of the rotary drum 40, thereby compensating the eccentricity of the rotary drum 40. Therefore, to allow the balls to move, the balls can roll freely within the race groove 41.

The cover member 45 prevents any mobile members 43 from escaping from the race groove 43. The cover member 45 is connected, preferably by press fit, with an inner circumferential wall 41a of the race groove 41. A supporting projection 42 for restricting a connection height of the cover member 45 protrudes from the inner circumferential wall 41a. Alternatively, the cover member 45 may be sized for a press fit with the outer circumferential wall 41b of the race groove 41.

The outer circumferential wall 41b of the race groove 41 has receiving recesses 41c for receiving the mobile members 43. The receiving recesses 41c are preferably arranged at constant intervals along the race groove 41. Preferably, the receiving recesses 41c are substantially semicircular indentation in the outer circumferential wall 41b of the race groove 41.

When the rotary drum 40 of the above-describe head drum assembly rotates, the mobile members 43 move away from the rotational axis due to centrifugal force. Therefore, the mobile members 43 move in a direction symmetrical to the eccentric point of the rotary drum 40, and are received in the receiving recesses 41c. Once received in the receiving recesses 41c, the mobile members 43 compensate for the eccentricity of the rotary drum 40.

When the eccentric point occurs at another location in the rotary drum 40, the mobile members 43 relocate, thereby automatically compensating for any changed eccentricity of the rotary drum 40.

In addition, any mobile members 43 that do not move toward the eccentric point are received in the receiving recesses 41c. Thus, any mobile members 43 which did not find the eccentric point are prevented from moving around within the race groove 41.

Accordingly, the rotary drum 40 can be driven without eccentricity and therefore operates stably without shaking or trembling. As a result, performance of recording and reproducing information on a magnetic tape can be enhanced.

Also, according to the above structure, the self-compensating dynamic balancer 70 is completely mounted by forming the race groove 41 in the rotary drum 40, inserting the mobile member 43 in the race groove 41 and connecting the cover member 45.

By connecting the rotary drum 40 with the compensation balancer 70 to the shaft 22 and assembling the stationary drum 30 and the drum cover 50, the head drum assembly 100 can be constructed in a simple manner. That is, the assembly does not require any special balancing processes. Accordingly, assembly steps and assembly time can be saved, thereby improving productivity and reducing manufacturing costs.

Furthermore, the self-compensating dynamic balancer is able to automatically compensate any eccentricity generated while driving the rotary drum. Thus, the eccentricity does not have to be measured for every rotary drum produced. Therefore, recording and reproducing characteristics can be enhanced by preventing shaking and trembling of the rotary drum.

While the invention has been shown and described with reference to certain embodiments thereof, it will be understood by those skilled in the art that various changes in form and details may be made therein without departing from the spirit and scope of the invention as defined by the appended claims.

What is claimed is:

1. A head drum assembly comprising:
a stationary drum fixed to a shaft;
a rotary drum rotatably mounted on the shaft, the rotary drum facing the stationary drum and supporting a magnetic head; and
a self-compensating dynamic balancer that automatically compensates for an eccentricity between the rotational axis and the centroid of the rotary drum based on the centrifugal force of the rotary drum when rotated.

2. The head drum assembly of claim 1, wherein the self-compensating dynamic balancer comprises:
a recessed race groove, the race groove being annular with respect to the rotational axis of the rotary drum; and
a plurality of mobile members received in the race groove, the mobile members movable in a direction that compensates for the eccentricity.

3. The head drum assembly of claim 2, wherein the self-compensating dynamic balancer further comprises:
a cover member that covers an open top portion of the race groove to prevent the mobile members from escaping from the race groove.

4. The head drum assembly of claim 3, wherein
the cover member is connected by press fit with an inner circumferential wall of the race groove.

5. The head drum assembly of claim 4, wherein
the inner circumferential wall of the race groove has a supporting projection for restricting a connection height of the cover member.

6. The head drum assembly of claim 2, wherein
the mobile members are balls.

7. The head drum assembly of claim 6, wherein
the outer circumferential wall of the race groove has a plurality of receiving recesses in which the balls are received when the rotary drum is rotated.

8. The head drum assembly of claim 7, wherein
the receiving recesses are disposed at constant intervals along the outer circumferential wall of the race groove.

9. The head drum assembly of claim 7, wherein
the receiving recesses are semicircular indentations formed in the outer circumferential wall of the race groove

10. The head drum assembly of claim 2, wherein
the race groove is formed on an upper surface of the rotary drum to face the magnetic head.

11. A magnetic recording/reproducing apparatus comprising:
a deck; and
a head drum assembly mounted to the deck, the head drum assembly comprising,
a stationary drum fixed to a shaft;
a rotary drum rotatably mounted on the shaft, the rotary drum facing the stationary drum and supporting a magnetic head; and
a self-compensating dynamic balancer that automatically compensates for an eccentricity between the rotational axis and the centroid of the rotary drum based on the centrifugal force of the rotary drum when rotated.

12. The magnetic recording/reproducing apparatus of claim 11, wherein the self-compensating dynamic balancer comprises:
a recessed race groove, the race groove being annular with respect to the rotational axis of the rotary drum; and
a plurality of mobile members received in the race groove, the mobile members movable in a direction that compensates for the eccentricity.

13. The magnetic recording/reproducing apparatus of claim 12, wherein the self-compensating dynamic balancer further comprises:
a cover member that covers an open top portion of the race groove to prevent the mobile members from escaping from the race groove.

14. The magnetic recording/reproducing apparatus of claim 12, wherein
the mobile members are metal balls.

15. The magnetic recording/reproducing apparatus of claim 12, wherein
the outer circumferential wall of the race groove has a plurality of receiving recesses in which the balls are received when the rotary drum is rotated.

16. A head drum assembly comprising:
a stationary drum fixed to a shaft;
a rotary drum rotatably mounted on the shaft, the rotary drum having an annular race groove;
a magnetic head mounted on the rotary drum;
at least one mobile member located in the annular race groove; and
a cover mounted on the rotary drum to prevent the mobile member from escaping from the race groove.

17. The head drum assembly of claim 16, wherein
the at least one mobile member comprises a plurality of metal balls.

18. The head drum assembly of claim 17, wherein
the annular groove has a plurality of receiving recesses for receiving the mobile members.

19. The head drum assembly of claim 16, wherein
the cover member is press fit to the rotary member.

20. The head drum assembly of claim 16, further comprising:
a drum motor for rotating the rotary drum.

21. A method of manufacturing a head drum assembly, comprising the steps of:
fixing a stationary drum to a shaft;
mounting a rotary drum on the shaft, the rotary drum having an annular race groove;
mounting a magnetic head on the rotary drum; and
providing at least one mobile member in the annular race groove.

22. The method of claim 21, further comprising the step of:
mounting a cover on the rotary drum to prevent the at least one mobile member from escaping from the annular race groove.
